(19) United States
(12) Patent Application Publication
(10) Pub. No.: US 2025/0356866 A1
(43) Pub. Date: Nov. 20, 2025

(54) AUDIO ENCODING AND DECODING METHOD AND APPARATUS, AND ELECTRONIC DEVICE

(71) Applicant: Douyin Vision Co., Ltd., Beijing (CN)

(72) Inventors: Jiawei JIANG, Beijing (CN); Linping Xu, Beijing (CN); Dejun Zhang, Beijing (CN); Li Chen, Beijing (CN); Yijian Xiao, Beijing (CN); Piao Ding, Beijing (CN); Shenyi Song, Beijing (CN)

(21) Appl. No.: 19/288,778

(22) Filed: Aug. 1, 2025

Related U.S. Application Data
(63) Continuation of application No. PCT/CN2024/075550, filed on Feb. 2, 2024.

(30) Foreign Application Priority Data
Feb. 3, 2023 (CN) 202310118855.3

(51) Int. Cl. G10L 19/038; G10L 25/30

(52) U.S. Cl. CPC G10L 19/038; G10L 25/30

(57) ABSTRACT

This disclosure relates to an audio encoding and decoding method and apparatus, and an electronic device. The audio encoding method includes: acquiring a frame of audio data to be processed; performing an encoding processing on the audio data based on a plurality of encoder blocks; wherein each encoder block of the plurality of encoder blocks comprises a first convolutional neural network and a recurrent neural network; and performing a feature quantization processing on a result after the encoding processing to obtain target encoded data of the audio data.

### CROSS-REFERENCE TO RELATED APPLICATIONS

This application is a Continuation Application of International Patent Application No. PCT/CN2024/075550, filed on February. 2, 2024, which is based on and claims priority to CN application Ser. No. 20/231,0118855.3, filed on Feb. 3, 2023, the disclosures of which are incorporated herein by reference in their entireties.

### TECHNICAL FIELD

The present disclosure relates to the field of communications, and in particular, to an audio encoding and decoding method and apparatus, and an electronic device.

### BACKGROUND

In the process that audio data is transmitted or stored, it needs to be encoded first, and after being transmitted or stored, it needs to be decoded when reconstructed. In a related audio encoding and decoding technology, a preset algorithm is usually adopted to encode an audio signal to obtain encoded data. Because the encoded data is large in volume, which is not beneficial to transmission and storage, the encoded data needs to be compressed, and after being transmitted or stored, the compressed data is decoded and restored.

Thus, the reconstructed audio data may lose much of the information in the original audio data. There is a need for an improved method of encoding and decoding audio data.

### SUMMARY

The disclosure provides an audio encoding and decoding method and apparatus, and an electronic device.

According to a first aspect, there is provided an audio encoding method, including:
acquiring a frame of audio data to be processed;
performing an encoding processing on the audio data based on a plurality of encoder blocks; where each encoder block of the plurality of encoder blocks includes a first convolutional neural network and a recurrent neural network; and
performing a feature quantization processing on a result after the encoding processing, to obtain target encoded data of the audio data.

According to a second aspect, there is provided an audio decoding method, including:
acquiring target encoded data; where the target encoded data is obtained by performing an encoding processing and then performing a quantization processing on a frame of audio data;
performing decoding processing on the target encoded data based on a plurality of decoder blocks, where each decoder block of the plurality of decoder blocks includes a first convolutional neural network and a recurrent neural network; and
converting a result after the decoding processing into target audio data.

According to a third aspect, there is provided an audio encoding apparatus, including:
an acquiring module configured to, acquire a frame of audio data to be processed;
a processing module configured to, perform encoding processing on the audio data based on a plurality of encoder blocks; where each encoder block of the plurality of encoder blocks includes a first convolutional neural network and a recurrent neural network; and
a quantizing module configured to, perform feature quantization processing on a result after the encoding processing, to obtain target encoded data of the audio data.

According to a fourth aspect, there is provided an apparatus for training a target model, the apparatus including:
an acquiring module configured to, acquire target encoded data; where the target encoded data is obtained by performing an encoding processing and then performing a quantization processing on a frame of audio data;
a processing module configured to, perform decoding processing on the target encoded data based on a plurality of decoder blocks, where each decoder block of the plurality of decoder blocks includes a first convolutional neural network and a recurrent neural network; and
a converting module configured to, convert a result after the decoding processing into target audio data.

According to a fifth aspect, there is provided a non-transitory computer-readable storage medium having stored a computer program which, when executed by a processor, implements the method of any of the first or second aspects.

According to a sixth aspect, there is provided an electronic device including a memory, a processor and a computer program stored on the memory and executable on the processor, the processor implementing the method of any of the first or second aspects when executing the program.

According to a seventh aspect, there is provided a computer program including: instructions which, when executed by a processor, cause the processor to perform the method of any of the first or second aspects.

The technical scheme provided by the embodiments of the present disclosure can have the following beneficial effects:

It is to be understood that both the foregoing general description and the following detailed description are exemplary and explanatory only and are not restrictive of the disclosure.

### BRIEF DESCRIPTION OF THE DRAWINGS

In order to more clearly illustrate the technical solutions of the embodiments in the specification, the drawings required to be used in the description of the embodiments will be briefly introduced below, and it is obvious that the drawings in the following description are only some embodiments described in the specification, and it is obvious for those skilled in the art that other drawings may be obtained from these drawings without creative labor.

FIG. 1 is a schematic diagram illustrating a scenario of audio processing according to some exemplary embodiments of the present disclosure;

FIG. 2A is a flow diagram illustrating an audio encoding method according to some exemplary embodiments of the present disclosure;

FIG. 2B1 and 2B2 are schematic diagrams illustrating a structure of an encoder block according to some exemplary embodiments of the present disclosure;

FIG. 2C is a schematic diagram illustrating a residual unit according to some exemplary embodiments of the present disclosure;

FIG. 2D is a schematic diagram illustrating another residual unit according to some exemplary embodiments of the present disclosure;

FIG. 2E is a schematic diagram illustrating another residual unit according to some exemplary embodiments of the present disclosure;

FIG. 2F is a schematic diagram illustrating another residual unit according to some exemplary embodiments of the present disclosure;

FIG. 2G is a schematic diagram illustrating another residual unit according to some exemplary embodiments of the present disclosure;

FIG. 2H is a schematic diagram illustrating another residual unit according to some exemplary embodiments of the present disclosure;

FIG. 2I is a schematic diagram illustrating an audio encoding method according to some exemplary embodiments of the present disclosure;

FIG. 3 is a flow diagram illustrating another audio decoding method according to some exemplary embodiments of the present disclosure;

FIG. 4 is a block diagram illustrating an audio encoding apparatus according to some exemplary embodiments of the present disclosure;

FIG. 5 is a block diagram illustrating another audio decoding apparatus according to some exemplary embodiments of the present disclosure;

FIG. 6 is a schematic block diagram of an electronic device according to some embodiments of the present disclosure;

FIG. 7 is a schematic block diagram of another electronic device according to some embodiments of the present disclosure;

FIG. 8 is a schematic diagram of a storage medium according to some embodiments of the present disclosure.

### DETAILED DESCRIPTION

In order to make those skilled in the art better understand the technical solutions in the specification, the technical solutions in the embodiments of the specification will be clearly and completely described below with reference to the drawings in the embodiments of the specification, and it is obvious that the described embodiments are only a part of the embodiments of the specification, and not all of the embodiments. All other embodiments obtained by a person of ordinary skill in the art based on the embodiments in the specification without making any creative effort shall fall within the protection scope of the specification.

When the following description refers to the drawings, the same numbers in different drawings represent the same or similar elements unless otherwise indicated. The implementations described in the exemplary embodiments below do not represent all implementations consistent with the present disclosure. Rather, they are merely examples of apparatus and methods consistent with certain aspects of the disclosure, as detailed in the appended claims.

The terminology used in the disclosure is for the purpose of describing particular embodiments only and is not intended to be limiting of the disclosure. As used in this disclosure, the singular forms “a”, “an” and “the” are intended to include the plural forms as well, unless the context clearly indicates otherwise. It should also be understood that the term “and/or” as used herein refers to and encompasses any and all possible combinations of one or more of the associated listed items.

It is to be understood that although the terms “first”, “second”, “third”, etc. may be used herein to describe various information, such information should not be limited to these terms. These terms are only used to distinguish one type of information from another. For example, first information may also be referred to as second information, and similarly, second information may also be referred to as first information, without departing from the scope of the present disclosure. The word “if,” as used herein, may be interpreted as “upon . . . ” or “when . . . ” or “in response to a determination”, depending on the context.

In the process that audio data is transmitted or stored, it needs to be encoded first, and after being transmitted or stored, it needs to be decoded when reconstructed. In a related audio encoding and decoding technology, a preset algorithm is usually adopted to encode an audio signal to obtain encoded data. Because the encoded data is large in volume, which is not beneficial to transmission and storage, the encoded data needs to be compressed, and after being transmitted or stored, the compressed data is decoded and restored. Thus, the reconstructed audio data may lose much of the information in the original audio data.

In the related art, by means of machine learning, in an encoding stage, a pre-trained encoder is used to encode and compress audio data, so as to obtain compressed feature data. By transmitting or storing the feature data, and decoding and restoring the feature data by using a decoder in an audio reconstruction stage, restored audio data is obtained. However, audio data includes rich timing information, and the related art does not sufficiently consider timing information in the audio data.

According to the audio encoding method provided by the disclosure, encoding processing is performed on each frame of audio data to be processed based on the convolutional neural network and the recurrent neural network, and feature quantization processing is performed on a result after the encoding processing, to obtain encoded target encoded data. Because the convolutional neural network is able to better extract detailed features of the audio signal, and the recurrent neural network is able to fully extract timing information of the audio signal, the target encoded data obtained by encoding the audio data is able to fully embody the timing information of one frame of audio data, thereby improving the audio encoding effect.

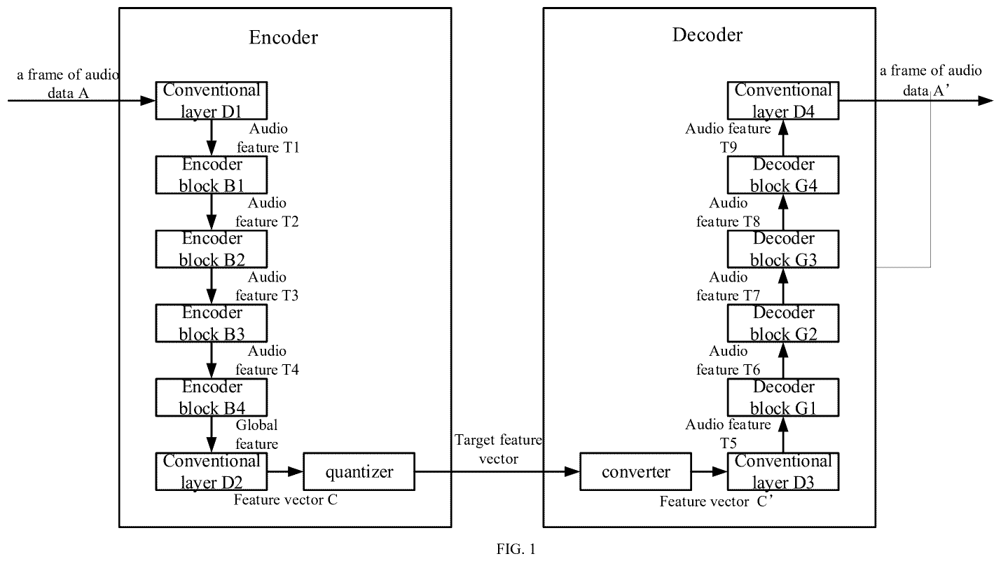

Referring to FIG. 1, it is a schematic diagram illustrating a scenario of audio processing according to some exemplary embodiments. Referring to FIG. 1, the disclosed solution is schematically illustrated in connection with an application example. The application example describes an audio processing procedure.

As shown in FIG. 1, an encoder is provided in an encoding-side device, and the encoder is sequentially disposed with a convolution layer D1, encoder blocks B1, B2, B3, B4, a convolution layer D2, and a quantizer. The encoder blocks B1, B2, B3, and B4 each may be composed of a convolutional neural network and a recurrent neural network. For example, first, a plurality of frames of one-dimensional audio data (for example, a duration of 20 ms per frame of audio data) may be acquired, and then the audio data may be processed frame by frame. For any one frame of audio data A, the frame of audio data A is input into the convolution layer D1 of the encoder, and the convolution layer D1 converts the one-dimensional audio data of the frame into two-dimensional audio features T1 on time domain dimension and frequency domain dimension. Then, the audio feature T1 is input into the encoder block B1, and after processing by the convolutional neural network and the recurrent neural network in the encoder block B1, a down-sampling processing is performed on the time domain dimension to obtain audio feature T2, where a size of the audio feature T2 on the time domain dimension is smaller than a size of the audio feature T1 on the time domain dimension. It is noted that a size of the audio feature T2 on the frequency domain dimension may be greater than or equal to a size of the audio feature T1 in the frequency domain dimension.

Then, the audio feature T2 is input into the encoder block B2, and after processing by the convolutional neural network and the recurrent neural network in the encoder block B2, a down-sampling processing is performed on the time domain dimension to obtain an audio feature T3, where a size of the audio feature T3 on the time domain dimension is smaller than the size of the audio feature T2 on the time domain dimension. By analogy, after processed by the encoder block B4, a global feature representing one frame of the frame of audio data is obtained. It should be noted that, in the process of processing the audio features by the convolutional neural network and the recurrent neural network included in the encoder block, the size of the audio features on the time domain dimension is compressed only in the down-sampling process without changing the size of the audio features.

Finally, the global feature is input into the convolutional layer D2, the convolutional layer D2 converts the global feature into a feature vector C with a designated dimension, and the feature vector C with the designated dimension is input into the quantizer for quantization processing to obtain a target feature vector for transmission or storage. A size of the target feature vector on the time domain dimension is smaller than the size of the audio feature T1, and the target feature vector is a feature vector compressed for the audio feature

T1 and is convenient to transmit and store. After a decoding-end device acquires the target feature vector, a frame of audio data A′ may be restored based on the target feature vector.

It should be noted that, the decoding-end device may use a decoder having a mirror structure of the encoder to decode the target feature vector, and may also use any other reasonable manner to decode the target feature vector, which is not limited in this aspect. The following is an exemplary description of the decoder having a mirror structure of the encoder.

For example, a decoder is provided in a decoding-side device, and the decoder is sequentially disposed with a converter, a convolution layer D3, decoder blocks G1, G2, G3, G4, and a convolution layer D4. In order to realize an inverse process of the encoding, the structures of the convolutional neural network and the recurrent neural network involved in the decoder are the same as the structures of the convolutional neural network and the recurrent neural network involved in the encoder, and an up-sampling layer involved in the decoder can be a transposed convolutional layer of the down-sampling layer involved in the encoder.

For example, first, the target feature vector may be acquired (for example, receiving the target feature vector transmitted by the encoding-end device through the communication channel, or reading the target feature vector from the storage medium, or the like), and the target feature vector is converted into a feature vector C′ by the converter. Note that, since the feature vector C is compressed into a target feature vector by a quantization processing, the target feature vector may lose a small amount of information compared to the feature vector C, and therefore, after the target feature vector is converted into the feature vector C′, the feature vector C′ is not completely identical with the feature vector C.

The feature vector C′ is input into the convolutional layer D3, and is converted by the convolutional layer D3 into an audio feature T5 of a designated dimension. Then, by inputting the audio feature T5 into the decoder block G1, performing the up-sampling processing, and after processing by a convolutional neural network and a recurrent neural network in the decoder block G1, audio feature T6 is obtained, where a size of the audio feature T6 on the time domain dimension is greater than a size of the audio feature T5 on the time domain dimension.

Then, the audio feature T6 is input into the decoder block G2, an up-sampling processing is performed on it first, and then after processing by the convolution neural network and the recurrent neural network in the decoder block G2, audio feature T7 is obtained, where a size of the audio feature T7 on the time domain dimension is greater than a size of the audio feature T6 on the time domain dimension. By analogy, after the processing by the decoder block G4, audio feature T9 is obtained. It should be noted that, in the process of processing the audio features by the convolutional neural network and the recurrent neural network included in the decoder block, the size of the audio features is extended on the time domain dimension only in the up-sampling process without changing the size of the audio features.

Finally, the audio feature T9 is input into the convolutional layer D4, and the convolutional layer D4 converts the audio feature T9 into one frame of one-dimensional audio data A′, and an audio-reconstruction can be performed based on the audio data A′. Note that, since the feature vector C, after the quantization process, will lose a small amount of data, the restored audio data A′ is not completely identical with the original audio data A, and is slightly distorted.

It should be noted that the encoder and the decoder may be trained together, or may be trained separately. If the encoder and the decoder are trained together, for example, sample audio data may be acquired first, the sample audio data is input to the encoder to be trained according to the information flow direction of FIG. 1, and then the target feature vector output by the encoder is input to the decoder to be trained to obtain the restored audio data output by the decoder. The sample audio data and the restored audio data are respectively input into a discriminator, and model parameters of the encoder and the decoder are adjusted based on the result output by the discriminator to finish the training of the model.

In addition, the encoder and decoder provided in the embodiment of FIG. 1 may be used together or separately. For example, in one scenario, the encoder and the decoder are deployed in an instant messaging client, and when a user uses the instant messaging client to make a call, if the instant messaging client serves as an audio data sending end, the encoder may be used to encode the audio data, and transmit the encoded feature vector to a receiving end. If the instant messaging client serves as an audio data receiving end, after the feature vector sent by the audio data sending end is received, the decoder may be used to decode the received feature vector to reproduce the audio data.

In another scenario, in the process of audio production, the encoder may be deployed in a device of a producer, and the producer may process and compress audio data by using the encoder to obtain an audio work, and store the audio work in a storage medium (such as an optical disc, etc.), or distribute the audio work in the internet for a user to enjoy. The decoder may be disposed in a device of a user, and the decoder may be used to decode the audio work to reproduce audio data corresponding to the audio work and play the audio data. It is understood that a decoder for decoding in other manners may be disposed in the device of the user, and the decoder for decoding in other manners may also decode the audio work to reproduce the audio data corresponding to the audio work.

The present disclosure will be described in detail below with reference to some examples.

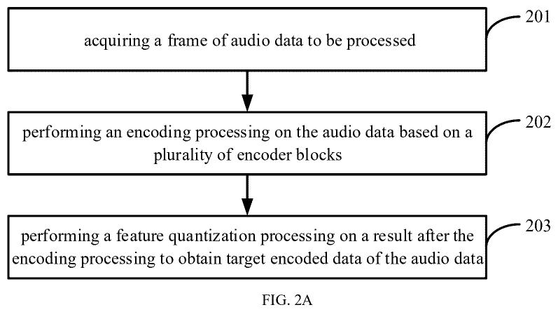

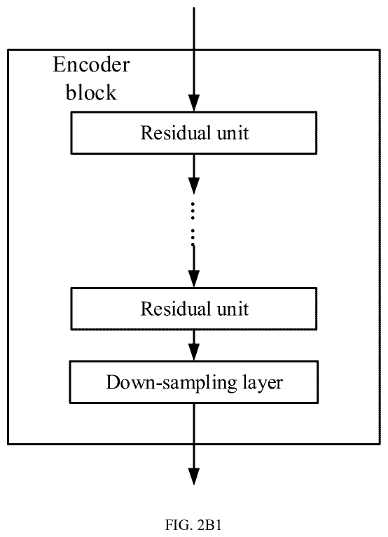

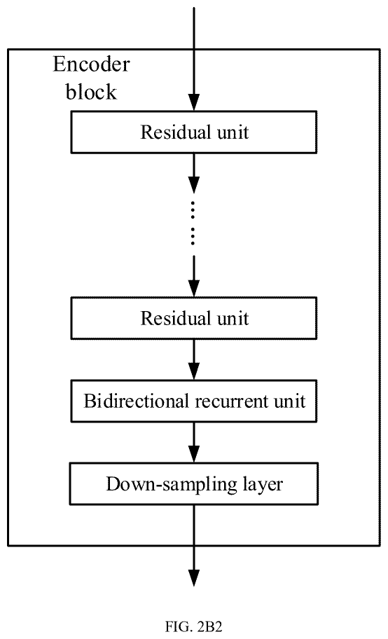

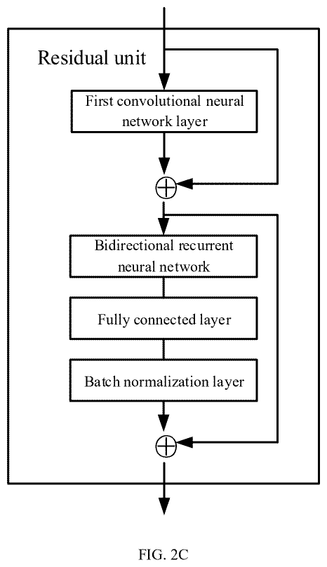

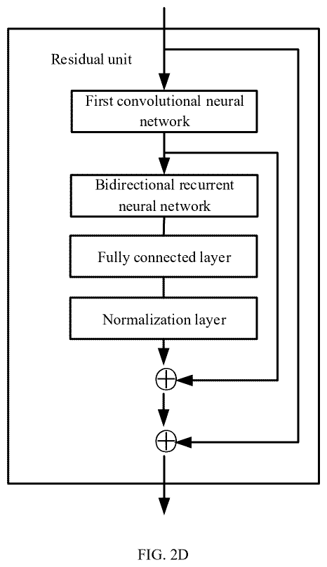

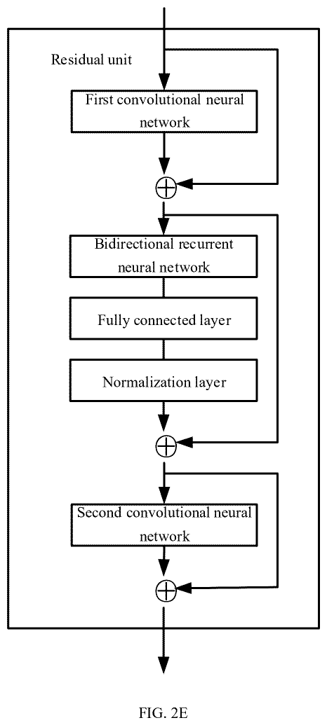

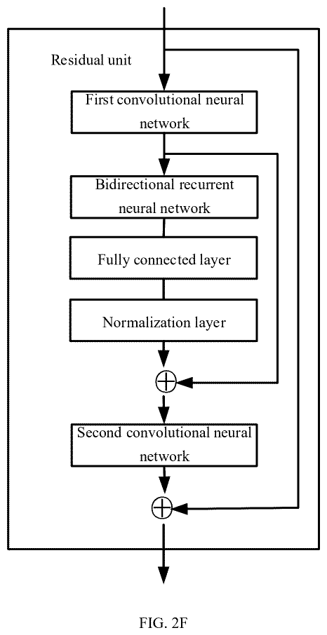

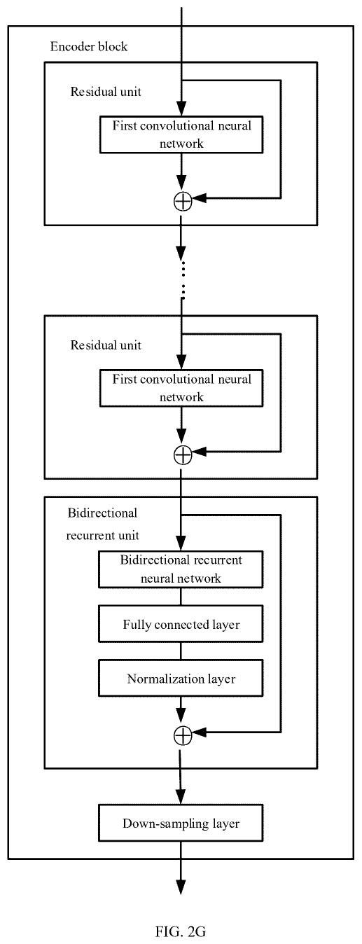

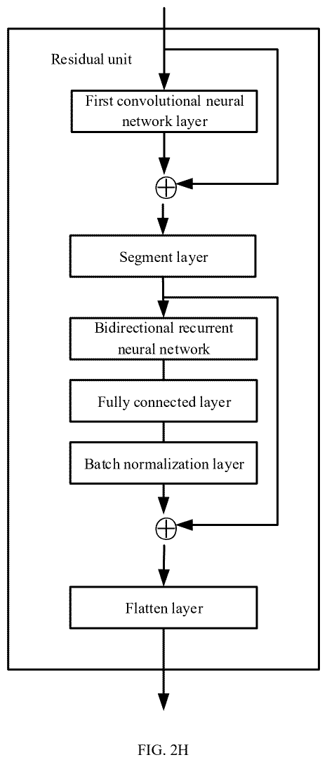

FIG. 2A is a flow diagram illustrating an audio encoding method according to some exemplary

embodiments, which may be applied to an encoding-side device. Those skilled in the art may appreciate that the encoding-side device may include, but is not limited to, a mobile terminal device such as a smart phone, a smart wearable device, a tablet computer, and any device, platform, server, or device cluster with computing and processing capabilities. The method may include the following steps:

As shown in FIG. 2A, in step 201, acquiring a frame of audio data to be processed.

Currently, when processing audio data, the audio data is usually processed frame by frame, and each frame of audio data has a fixed duration (for example, the duration of each frame of audio data is 20 ms).

In step 202, performing an encoding processing on the audio data based on a plurality of encoder blocks.

In the embodiments, each encoder block may include a first convolutional neural network and a recurrent neural network, so that the convolutional neural network and the recurrent neural network that are disposed alternately are used to process the audio features alternately. Since depth of the encoder network is increased in this implementation, the performance of the encoder network is improved, making the processing effect of the audio features better. Alternatively, the recurrent neural network may employ a bidirectional recurrent neural network (Bi-RNN), thereby enhancing contextual relevance of timing information extracted from the audio features.

For example, the encoding-side device is provided with an encoder, which may include a plurality of encoder blocks (see FIG. 1), and a plurality of encoding operations may be performed using the plurality of encoder blocks, respectively, to perform encoding processing on the audio features. FIG. 2B1 and 2B2 show schematic diagrams of an encoder block, and as shown in FIG. 2B1 and 2B2, each encoder block includes a plurality of residual units and a down-sampling layer (e.g., a convolutional layer may be used as the down-sampling layer). Each residual unit may include a first convolutional neural network and a recurrent neural network. Any one encoder block can perform one encoding operation in the following manner: first, determining data to be processed. If the encoder block is a first encoder block, the data to be processed is the audio data, and if the encoder block is not the first encoder block, the data to be processed is a processing result of the previous encoder block. And then, the data to be processed is input into the residual unit of the encoder block, and is sequentially processed by the convolutional neural network and the recurrent neural network included in the residual unit of the encoder block to obtain an intermediate feature which is down-sampled, to compress the first feature.

In the embodiments, each residual unit may be formed by a Convolutional Neural Network (CNN) and a Recurrent Neural Network (RNN), and for example, in an implementation, each residual unit sequentially includes a first Convolutional Neural Network, a Recurrent Neural Network fully connected (FC) layer, and a Batch Normalization (BN) layer. FIG. 2C and FIG. 2D show a schematic structural diagram of a residual unit, and as shown in FIG. 2C, after the data to be processed is input into one residual unit, the data is processed by the first convolutional neural network, and then once residual addition is performed (symbol ⊕ in the figure indicates residual addition, that is, the input data and the output data pointing to the symbol ⊕ are added). And after the processing by the recurrent neural network, the fully connected layer and the batch normalization layer, once residual addition is performed again. As shown in FIG. 2D, after the data to be processed is input to a residual subunit, it is first processed by the first convolutional neural network, and then is processed by the recurrent neural network, the fully connected layer, and the batch normalization layer, and then once residual addition is performed. The feature processed in the implementation has a better coding effect.

In another implementation, each residual unit sequentially includes a first convolutional neural network, a recurrent neural network, a fully connected layer, a batch normalization layer and a second convolutional neural network. FIG. 2E and FIG. 2F show a schematic structural diagram of a residual unit, and as shown in FIG. 2E, after the data to be processed is input into one residual unit, the data is processed by the first convolutional neural network, and then once residual addition is performed. And after processing by the recurrent neural network, the fully connected layer and the batch normalization layer, once residual addition is performed again. Finally, after processing by the second convolution neural network, residual addition is performed again. As shown in FIG. 2F, after the data to be processed is input to one residual subunit, the data is processed by the first convolutional neural network, and then after processed by the recurrent neural network, the fully connected layer, and the batch normalization layer, once residual addition is performed. And after processing by the second convolution neural network, once residual addition is performed again.

In yet another implementation, each encoder block includes a plurality of residual units, a bidirectional recurrent unit, and a down-sampling layer (e.g., a convolutional layer may be employed as the down-sampling layer). Each residual unit includes a first convolution neural network, the bidirectional recurrent unit includes a recurrent neural network, a fully connected layer and a batch normalization layer, where the recurrent neural network, the fully connected layer and the batch normalization layer are sequentially connected in series. FIG. 2G shows a schematic structural diagram of another encoder block, and as shown in FIG. 2G, the encoder block includes a plurality of residual units, a bidirectional recurrent unit and a down-sampling layer which are sequentially connected in series. After the data to be processed is input into the residual unit, it is processed by the first convolution neural network, and then once residual addition is performed. And after processing by the plurality of residual units, the data is input into the bidirectional recurrent unit, and after processed by the recurrent neural network, the fully connected layer and the batch normalization layer, once residual addition is performed again. The feature processed in the implementation has a higher coding efficiency.

In step 203, performing a feature quantization processing on a result after the encoding processing, to obtain target encoded data of the audio data.

In the embodiments, the feature quantization processing may be performed on the result after the encoding processing to obtain the target encoded data, and for example, the result after the encoding processing may be converted into a feature vector of a designated dimension by the convolutional layer, and then the feature vector of the designated dimension is converted into a feature vector in a preset codebook by the preset codebook, so as to obtain the target encoded data. For example, Residual Vector Quantization (RVQ) may be used to perform feature quantization processing on the result after the encoding processing. It is understood that any other manners of performing the feature quantization processing known in the art and that may occur in the future can be applied to the present disclosure, and specific quantization processing manners are not limited in the present disclosure.

It should be noted that, as shown in FIG. 2H, in a training phase, since most of the sample audio

data is complete audio data with a long duration, a segment layer needs to be added before each recurrent neural network included in the encoder, and a flatten layer needs to be added after each recurrent neural network. The segment layer may be configured to segment two-dimensional audio feature into a plurality of subframes on the time domain, and splice the plurality of subframes into a three-dimensional audio feature. As shown in FIG. 2I, for example, taking two-dimensional audio feature 211 converted from the sample audio data as an example, the duration of the audio feature 211 is L, and the number of channels is C. The audio feature 211 may be input to the segment layer, which segments the audio feature 211 of the duration L into K subframes each of length S. If the length of the last frame is not enough to be S (i.e. L cannot be divisible by K), the length of the last frame can be adjusted to be S by complementing 0. Then, the K subframes each of length S are spliced into a three-dimensional audio feature 212, and the three-dimensional audio feature 212 is added with a dimension representing the number of subframes than the audio feature 211.

The three-dimensional audio feature 212 is processed by a bidirectional recurrent neural network, timing information within a frame is extracted, and after passing through subsequent fully connected layer and batch normalization layer, residuals addition is performed with the input three-dimensional audio feature 212. And then by splicing by the flatten layer, a two-dimensional audio feature 213 is obtained. For example, the flatten layer may sequentially connect the K subframes each of length S into the two-dimensional audio feature 213 according to a time sequence, where the two-dimensional audio feature 213 is reduced by a dimension representing the number of subframes than the three-dimensional audio feature 212.

According to the audio encoding method provided by the disclosure, encoding processing is performed on each frame of audio data to be processed based on the convolutional neural network and the recurrent neural network, and feature quantization processing is performed on a result after the encoding processing, to obtain encoded target encoded data. Because the convolutional neural network can better extract detailed features of the audio signal, and the recurrent neural network can fully extract timing information of the audio signal, the target encoded data obtained by encoding the audio data can fully embody the timing information of one frame of audio data, thereby improving the audio encoding effect.

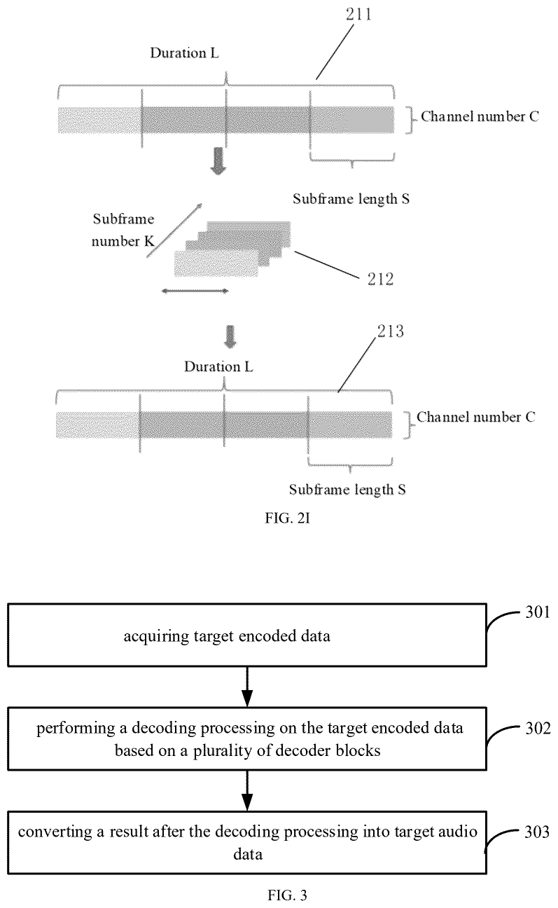

FIG. 3 is a flow diagram illustrating another audio decoding method according to some example embodiments, that may be applied in a decoding-side device. Those skilled in the art may appreciate that the decoding-side device may include, but is not limited to, a mobile terminal device such as a smart phone, a smart wearable device, a tablet computer, and any device, platform, server, or device cluster with computing and processing capabilities. The method may include the following steps:

As shown in FIG. 3, in step 301, acquiring target encoded data.

In step 302, performing decoding processing on the target encoded data based on a plurality of decoder blocks, and in step 303, converting a result after the decoding processing into target audio data.

In the embodiments, the target encoded data may be obtained by performing an encoding processing and then performing a quantization processing on a frame of audio data, for example, the target encoded data may be obtained by performing an encoding processing on a frame of audio data by using the encoding method provided in the embodiment of FIG. 2A. Therefore, after the target encoded data is acquired, the target encoded data can be converted into the data to be processed of the designated dimension based on a preset codebook (which is consistent with the preset codebook used by the encoder for quantization processing).

In the embodiments, each decoder block includes a first convolutional neural network and a recurrent neural network, where the recurrent neural network may be a bidirectional recurrent neural network. For example, a plurality of decoding operations may be performed by using a plurality of decoder blocks, respectively, to perform decoding processing on the data to be processed.

In one implementation, the plurality of decoder blocks are connected in series, each decoder block of the plurality of decoder blocks includes a plurality of residual units each including the first convolutional neural network, the recurrent neural network, a fully connected layer, and a batch normalization layer, and in the residual unit, the first convolutional neural network, the recurrent neural network, the fully connected layer, and the batch normalization layer are sequentially connected in series.

For example, any residual unit of the plurality of residual units may be subjected to the decoding processing as follows: inputting the data to be processed into a first convolutional neural network included in the residual unit to obtain a third feature, where in response to the residual unit being a first residual unit in the plurality of residual units, the data to be processed is a result after the decoding processing, and in response to the residual unit being not the first residual unit in the plurality of residual units, the data to be processed is an output feature of a previous residual unit of the residual unit; performing a residual processing on the data to be processed and the third feature to obtain a fourth feature, and inputting the fourth feature into a recurrent neural network included in the residual unit to obtain a fifth feature; inputting the fifth feature into a fully connected layer included in the residual unit to obtain a sixth feature, and inputting the sixth feature into a batch normalization layer to obtain a seventh feature; performing a residual processing on at least the seventh feature and the fourth feature to obtain a target feature, where the target feature is data to be processed input to a next residual unit or a result after the decoding processing.

In another implementation, the plurality of decoder blocks are connected in series, each decoder block of the plurality of decoder blocks including a plurality of residual units each including the first convolutional neural network. each decoder block further includes a bidirectional recurrent unit which includes the recurrent neural network, a fully connected layer and a batch normalization layer, where the recurrent neural network, the fully connected layer and the batch normalization layer are sequentially connected in series.

For example, any decoder block of the plurality of decoder blocks may be subjected to the feature processing as follows: inputting the feature to be processed into a plurality of residual units of the decoder block for processing to obtain a third feature, inputting the third feature into a bidirectional recurrent unit of the decoder block to obtain a fourth feature, and performing a residual processing on the fourth feature and the third feature to obtain a target feature, where the target feature is data to be processed input into a next decoder block or a result after the decoding processing.

It should be noted that the decoding processing performed by the decoding-side device may be an inverse process of the encoding processing performed by the encoding-side device, the structures of the convolutional neural network and the recurrent neural network involved in the decoding-side device are both the same as the structures of the convolutional neural network and the recurrent neural network involved in the encoding-side device, and the up-sampling layer involved in the decoding-side device may be a transposed convolutional layer of the down-sampling layer involved in the encoding-side device. And in the encoding process, the audio features to be processed are processed first by the convolutional neural network and the recurrent neural network, and then down-sampling processing is performed. In the decoding process, data to be processed is subjected to up-sampling processing, and then is processed by a convolutional neural network and a recurrent neural network. Based on this, the specific decoding process and the specific structure of the decoder block deployed in the decoding-side device are not described herein again, and refer to the encoding process and the structure of the encoder block deployed in the encoding-side device provided in the embodiments of FIG. 2A.

According to the audio decoding method provided by the present disclosure, by acquiring target encoded data which is obtained by performing an encoding processing and then performing a quantization processing on a frame of audio data, and performing decoding processing on the target encoded data based on a convolutional neural network and a recurrent neural network, and then converting a result after the decoding processing into target audio data, the target audio data comprises richer timing information, thereby improving the audio decoding effect.

It should be noted that although in the above embodiments, the operations of the methods of the embodiments of the present disclosure are described in a particular order, this does not require or imply that these operations must be performed in this particular order, or that all of the illustrated operations must be performed, in order to achieve desirable results. Rather, the steps depicted in the flow diagrams may change their order of execution. Additionally or alternatively, certain steps may be omitted, multiple steps may be combined into one step for execution, and/or one step may be broken down into multiple steps for execution.

Corresponding to the foregoing audio encoding and decoding method embodiments, the present disclosure also provides embodiments of an audio encoding and decoding apparatus.

As shown in FIG. 4, FIG. 4 is a block diagram illustrating an audio encoding apparatus according to some exemplary embodiments, which is disposed in an encoding-side device, and may include: an acquiring module 401, a processing module 402 and a quantizing module 403.

The acquiring module 401 is configured to acquire a frame of audio data to be processed.

The processing module 402 is configured to perform encoding processing on the audio data based on a plurality of encoder blocks; where each encoder block of the plurality of encoder blocks includes a first convolutional neural network and a recurrent neural network.

The quantizing module 403 is configured to perform feature quantization processing on a result after the encoding processing, to obtain target encoded data of the audio data.

In some embodiments, the recurrent neural network includes a bidirectional recurrent neural network.

In other embodiments, the plurality of encoder blocks are connected in series, where each encoder block of the plurality of encoder blocks includes a plurality of residual units each including the first convolutional neural network, the recurrent neural network, a fully connected layer, and a batch normalization layer, where in the residual unit, the first convolutional neural network, the recurrent neural network, the fully connected layer, and the batch normalization layer are sequentially connected in series.

In other embodiments, any residual unit of the plurality of residual units is subjected to the encoding processing by: inputting data to be processed into the first convolutional neural network included in the residual unit to obtain a third feature, where in response to the residual unit being a first residual unit in the plurality of residual units, the data to be processed is the audio data; where in response to the residual unit being not the first residual unit in the plurality of residual units, the data to be processed is output data of a previous residual unit of the residual unit; performing a residual processing on the data to be processed and the third feature to obtain a fourth feature, inputting the fourth feature into the recurrent neural network included in the residual unit to obtain a fifth feature, and inputting the fifth feature into the fully connected layer included in the residual unit to obtain a sixth feature; and inputting the sixth feature into the batch normalization layer to obtain a seventh feature, and performing a residual processing on at least the seventh feature and the fourth feature to obtain a target feature, where the target feature is data to be processed input into a next residual unit or a result after the encoding processing.

In further embodiments, each residual unit further includes a second convolutional neural network connected in series after the batch normalization layer in the residual unit, where the performing a residual processing on at least the seventh feature and the fourth feature to obtain a target feature is by: performing the residual processing on the seventh feature and the fourth feature to obtain an eighth feature, inputting the eighth feature into a second convolution neural network included in the residual unit to obtain a ninth feature, and performing a residual processing on the eighth feature and the ninth feature to obtain a target feature, where the target feature is data to be processed input into a next residual unit or a result after the encoding processing.

In other embodiments, any residual unit of the plurality of residual units is subjected to the encoding processing by: inputting data to be processed into the first convolutional neural network included in the residual unit to obtain a third feature, where in response to the residual unit being a first residual unit in the plurality of residual units, the data to be processed is the audio data; where in response to the residual unit being not the first residual unit in the plurality of residual units, the data to be processed is output data of a previous residual unit of the residual unit; inputting the third feature into the recurrent neural network included in the residual unit to obtain a fourth feature, inputting the fourth feature into the fully connected layer included in the residual unit to obtain a fifth feature, inputting the fifth feature into the batch normalization layer to obtain a sixth feature, and obtaining a target feature based on the sixth feature, the data to be processed and the third feature, where the target feature is data to be processed input into a next residual unit or a result after the encoding processing.

In other embodiments, the obtaining a target feature based on the sixth feature, the data to be processed, and the third feature is by: performing a residual processing on the sixth feature, the data to be processed and the third feature to obtain the target feature.

In other embodiments, each residual unit further includes a second convolutional neural network connected in series after the batch normalization layer in the residual unit.

The obtaining a target feature based on the sixth feature, the data to be processed, and the third feature is by: performing a residual processing on the sixth feature and the third feature to obtain a seventh feature, inputting the seventh feature into the second convolutional neural network included in the residual unit to obtain an eighth feature, and performing a residual processing on the eighth feature and the data to be processed to obtain a target feature, where the target feature is data to be processed input to a next residual unit or a result after the encoding processing.

In some embodiments, the plurality of encoder blocks are connected in series, where each encoder block of the plurality of encoder blocks includes a plurality of residual units each including the first convolutional neural network, the each encoder block further includes a bidirectional recurrent unit which includes the recurrent neural network, a fully connected layer, and a batch normalization layer, where the recurrent neural network, the fully connected layer, and the batch normalization layer are sequentially connected in series.

In other embodiments, any encoder block of the plurality of encoder blocks is subjected to the encoding processing by: inputting data to be processed into the plurality of residual units of the encoder block for processing to obtain a third feature, inputting the third feature into the bidirectional recurrent unit of the encoder block to obtain a fourth feature, and performing a residual processing on the fourth feature and the third feature to obtain a target feature, where the target feature is data to be processed input into a next encoder block or a result after the encoding processing.

As shown in FIG. 5, FIG. 5 is a block diagram illustrating an audio decoding apparatus according to some exemplary embodiments, which is disposed in a decoding-side device, and may include: an acquiring module 501, a processing module 502 and a converting module 503.

The acquiring module 501 is configured to acquire target encoded data, where the target encoded data is obtained by performing an encoding processing and then performing a quantization processing on a frame of audio data.

The processing module 502 is configured to perform decoding processing on the target encoded data based on a plurality of decoder blocks, where each decoder block of the plurality of decoder blocks includes a first convolutional neural network and a recurrent neural network.

The converting module 503 is configured to convert a result after the decoding processing into target audio data.

In some embodiments, the plurality of decoder blocks are connected in series, where each decoder block of the plurality of decoder blocks includes a plurality of residual units each including the first convolutional neural network, the recurrent neural network, a fully connected layer, and a batch normalization layer, where in the residual unit, the first convolutional neural network, the recurrent neural network, the fully connected layer, and the batch normalization layer are sequentially connected in series.

In other embodiments, any residual unit of the plurality of residual units is subjected to the decoding processing by: inputting data to be processed into the first convolutional neural network included in the residual unit to obtain a third feature, where in response to the residual unit being a first residual unit in the plurality of residual units, the data to be processed is the target encoded data; where in response to the residual unit being not the first residual unit in the plurality of residual units, the data to be processed is output data of a previous residual unit of the residual unit; performing a residual processing on the data to be processed and the third feature to obtain a fourth feature, and inputting the fourth feature into the recurrent neural network included in the residual unit to obtain a fifth feature; inputting the fifth feature into the fully connected layer included in the residual unit to obtain a sixth feature, inputting the sixth feature into the batch normalization layer to obtain a seventh feature, and performing a residual processing on at least the seventh feature and the fourth feature to obtain a target feature, where the target feature is data to be processed input into a next residual unit or a result after the decoding processing.

In further embodiments, the plurality of decoder blocks are connected in series, where each decoder block of the plurality of decoder blocks includes a plurality of residual units each including the first convolutional neural network; each decoder block of the plurality of decoder blocks further includes a bidirectional recurrent unit which includes the recurrent neural network, a fully connected layer and a batch normalization layer, where the recurrent neural network, the fully connected layer and the batch normalization layer are sequentially connected in series.

In other embodiments, any decoder block of the plurality of decoder blocks is subjected to feature processing by: inputting data to be processed into the plurality of residual units of the decoder block for processing to obtain a third feature, and inputting the third feature into the bidirectional recurrent unit of the decoder block to obtain a fourth feature; and performing a residual processing on the fourth feature and the third feature to obtain a target feature, where the target feature is data to be processed input to a next decoder block or a result after the decoding processing.

For the apparatus embodiments, since they basically correspond to the method embodiments, reference may be made to the partial description of the method embodiments for relevant points. The above-described apparatus embodiments are merely illustrative, and the units described as separate parts may or may not be physically separate, and parts displayed as units may or may not be physical units, may be located in one position, or may be distributed on multiple network units. Some or all of the modules may be selected according to actual needs to achieve the purposes of the embodiments of the present disclosure. One of ordinary skill in the art can understand and implement without creative efforts.

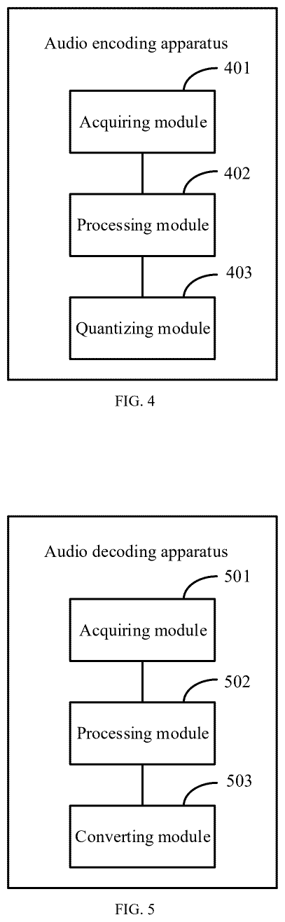

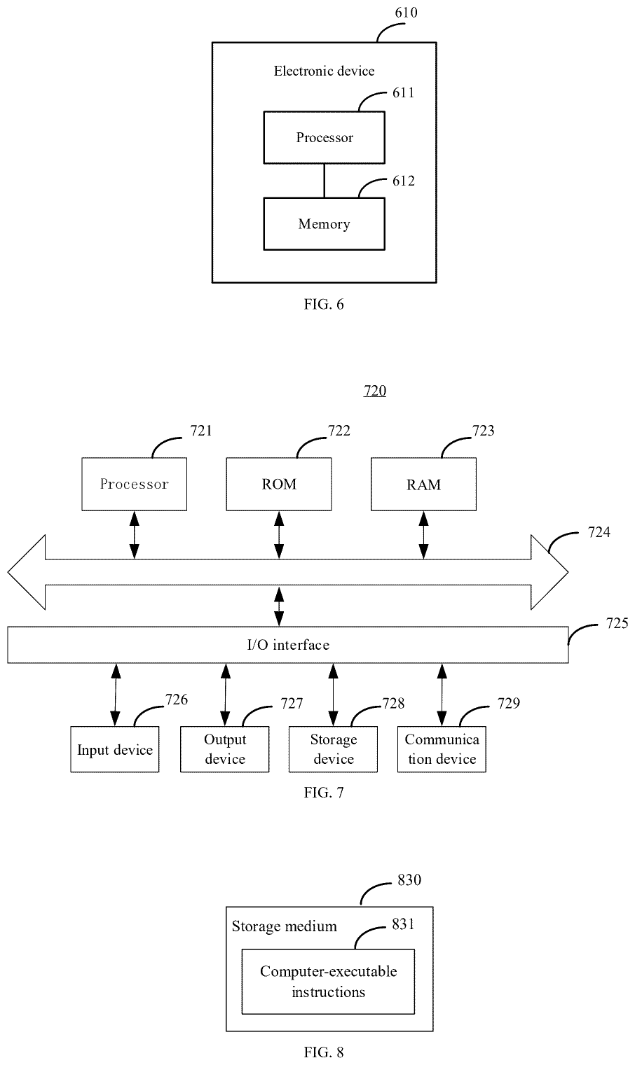

FIG. 6 is a schematic block diagram of an electronic device according to some embodiments of the present disclosure. As shown in FIG. 6, an electronic device 610 includes a processor 611 and a memory 612, which may be used to implement a client or a server. The memory 612 is used to store, non-transitory, computer-executable instructions (e.g., one or more computer program modules). The processor 611 is configured to execute the computer-executable instructions, which when executed by the processor 611 may perform one or more steps of the audio encoding and decoding method described above, thereby implementing the audio encoding and decoding method described above. The memory 612 and the processor 611 may be interconnected by a bus system and/or other form of connection mechanism (not shown).

For example, the processor 611 may be a Central Processing Unit (CPU), a Graphics Processing Unit (GPU), or other forms of processing unit having data processing capabilities and/or program execution capabilities. For example, the Central Processing Unit (CPU) may be an X86 or ARM architecture, or the like. The processor 611 may be a general-purpose processor or a special-purpose processor and may control other components in the electronic device 610 to perform desired functions.

For example, the memory 612 may include any combination of one or more computer program products that may include various forms of computer-readable storage media, such as volatile memory and/or non-volatile memory. The volatile memory can include, for example, Random Access Memory (RAM), cache, and/or the like. The non-volatile memory may include, for example, Read Only Memory (ROM), hard disk, Erasable Programmable Read Only Memory (EPROM), Portable Compact Disk Read Only Memory (CD-ROM), USB memory, flash memory, and the like. One or more computer program modules may be stored on the computer-readable storage medium and executed by the processor 611 to implement various functions of the electronic device 610. Various applications and various data, as well as various data used and/or generated by the applications, etc., may also be stored in the computer-readable storage medium.

It should be noted that, in the embodiments of the present disclosure, specific functions and technical effects of the electronic device 610 may refer to the description about the audio encoding and decoding method above, and are not described herein again.

FIG. 7 is a schematic block diagram of another electronic device according to some embodiments of the present disclosure. An electronic device 720 is, for example, suitable for use in implementing the audio encoding and decoding methods provided by embodiments of the present disclosure. The electronic device 720 may be a terminal device or the like, and may be used to implement a client or a server. The electronic device 720 may include, but is not limited to, mobile terminals such as mobile phones, notebook computers, digital broadcast receivers, PDAs (personal digital assistants), PADs (tablet computers), PMPs (portable multimedia players), in-vehicle terminals (e.g., in-vehicle navigation terminals), wearable electronic devices, and the like, and stationary terminals such as digital TVs, desktop computers, smart home devices, and the like. It should be noted that the electronic device 720 shown in FIG. 7 is only one example, and does not bring any limitation to the functions and the scope of the application of the embodiments of the present disclosure.

As shown in FIG. 7, the electronic device 720 may include a processor (e.g., central processing unit, graphics processor, etc.) 721 that may perform various appropriate actions and processes in accordance with a program stored in a Read Only Memory (ROM) 722 or a program loaded from a storage means 728 into a Random Access Memory (RAM) 723. In the RAM 723, various programs and data necessary for the operation of the electronic device 720 are also stored. The processor 721, the ROM722, and the RAM 723 are connected to each other by a bus 724. An input/output (I/O) interface 725 is also connected to bus 724.

Generally, the following means may be connected to I/O interface 725: input device 726 including, for example, a touch screen, touch pad, keyboard, mouse, camera, microphone, accelerometer, gyroscope, or the like; output device 727 including, for example, a Liquid Crystal Display (LCD), speaker, vibrator, or the like; storage device 728 including, for example, magnetic tape, hard disk, and the like; and communication device 729. The communication device 729 can allow the electronic device 720 to communicate wirelessly or by wire with other electronic devices to exchange data. While FIG. 7 illustrates the electronic device 720 as having various means, it is to be understood that not all illustrated means are required to be implemented or provided and that the electronic device 720 may alternatively be implemented or provided with more or less means.

For example, according to an embodiment of the present disclosure, the above-described audio encoding and decoding methods may be implemented as computer software programs. For example, the embodiments of the present disclosure include a computer program product including a computer program carried on a non-transitory computer readable medium, the computer program including program code for performing the audio encoding and decoding methods described above. In such an embodiment, the computer program may be downloaded and installed over a network through the communication means 729, or installed from the storage means 728 or ROM 722. When the computer program is executed by the processor 721, the functions defined in the audio encoding and decoding methods provided by the embodiments of the present disclosure may be implemented.

FIG. 8 is a schematic diagram of a storage medium according to some embodiments of the present disclosure. For example, as shown in FIG. 8, a storage medium 830 may be a non-transitory computer-readable storage medium for storing non-transitory computer-executable instructions 831. The audio encoding and decoding methods described in embodiments of the disclosure may be implemented when the non-transitory computer-executable instructions 831 are executed by a processor, e.g., one or more steps of the audio encoding and decoding methods described above may be performed when the non-transitory computer-executable instructions 831 are executed by a processor.

For example, the storage medium 830 may be applied to the electronic device described above, and for example, the storage medium 830 may include a memory in the electronic device.

For example, the storage medium may include a memory card of a smart phone, a storage component of a tablet computer, a hard disk of a personal computer, a Random Access Memory (RAM), a Read Only Memory (ROM), an Erasable Programmable Read Only Memory (EPROM), a portable compact disc read only memory (CD-ROM), a flash memory, or any combination of the above storage media, and may also be other suitable storage media.

For example, the description of the storage medium 830 may refer to the description of the memory in the embodiment of the electronic device, and repeated descriptions are omitted. Specific functions and technical effects of the storage medium 830 can refer to the above description of the audio encoding and decoding method, and are not described herein again.

In the context of this disclosure, the computer-readable medium may be any tangible medium that can contain, or store a program for use by or in connection with an instruction execution system, apparatus, or device. The computer readable medium may be a computer readable signal medium or a computer readable storage medium or any combination of the two. The computer readable storage medium may be, for example, but is not limited to: an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

Other embodiments of the disclosure will be apparent to those skilled in the art from consideration of the specification and practice of the disclosure herein. This disclosure is intended to cover any variations, uses, or adaptations of the disclosure that follow general principles of the disclosure and include common knowledge or customary technical means in the art not disclosed in the present disclosure. It is intended that the specification and the embodiments be considered as exemplary only, with a true scope and spirit of the disclosure being indicated by the following claims.

It will be understood that the present disclosure is not limited to the precise arrangements that have been described above and shown in the drawings, and that various modifications and changes may be made without departing from the scope thereof. The scope of the present disclosure is limited only by the appended claims.

What is claimed is:

1. An audio encoding method, comprising:
acquiring a frame of audio data to be processed;
performing an encoding processing on the audio data based on a plurality of encoder blocks; wherein each encoder block of the plurality of encoder blocks comprises a first convolutional neural network and a recurrent neural network; and
performing a feature quantization processing on a result after the encoding processing to obtain target encoded data of the audio data.

2. The audio encoding method according to claim 1, wherein the recurrent neural network comprises a bidirectional recurrent neural network.

3. The audio encoding method according to claim 1, wherein the plurality of encoder blocks are connected in series, the each encoder block comprises a plurality of residual units, each residual unit of the plurality of residual units comprises the first convolutional neural network, the recurrent neural network, a fully connected layer, and a batch normalization layer, and in the each residual unit, the first convolutional neural network, the recurrent neural network, the fully connected layer, and the batch normalization layer are sequentially connected in series.

4. The audio encoding method according to claim 3, wherein any residual unit of the plurality of residual units is subjected to the encoding processing by:
inputting data to be processed into the first convolutional neural network comprised in the residual unit to obtain a third feature, wherein in response to the residual unit being a first residual unit in the plurality of residual units, the data to be processed is the audio data; wherein in response to the residual unit being not the first residual unit in the plurality of residual units, the data to be processed is output data of a previous residual unit of the residual unit;
performing a residual processing on the data to be processed and the third feature to obtain a fourth feature;
inputting the fourth feature into the recurrent neural network comprised in the residual unit to obtain a fifth feature;
inputting the fifth feature into the fully connected layer comprised in the residual unit to obtain a sixth feature;
inputting the sixth feature into the batch normalization layer to obtain a seventh feature, and
performing a residual processing on at least the seventh feature and the fourth feature to obtain a target feature; wherein the target feature is data to be processed input into a next residual unit or a result after the encoding processing.

5. The audio encoding method according to claim 4, wherein the each residual unit further comprises a second convolutional neural network connected in series after the batch normalization layer in the residual unit;
wherein the performing the residual processing on at least the seventh feature and the fourth feature to obtain the target feature, comprises:
performing the residual processing on the seventh feature and the fourth feature to obtain an eighth feature;
inputting the eighth feature into a second convolution neural network comprised in the residual unit to obtain a ninth feature, and
performing a residual processing on the eighth feature and the ninth feature to obtain a target feature; wherein the target feature is the data to be processed input into the next residual unit or the result after the encoding processing.

6. The audio encoding method according to claim 3, wherein any residual unit of the plurality of residual units is subjected to the encoding processing by:
inputting data to be processed into the first convolutional neural network comprised in the residual unit to obtain a third feature; wherein in response to the residual unit being a first residual unit in the plurality of residual units, the data to be processed is the audio data, and in response to the residual unit being not the first residual unit in the plurality of residual units, the data to be processed is output data of a previous residual unit of the residual unit;
inputting the third feature into the recurrent neural network comprised in the residual unit to obtain a fourth feature;
inputting the fourth feature into the fully connected layer comprised in the residual unit to obtain a fifth feature;
inputting the fifth feature into the batch normalization layer to obtain a sixth feature, and
obtaining a target feature based on the sixth feature, the data to be processed and the third feature; wherein the target feature is data to be processed input into a next residual unit or a result after the encoding processing.

7. The audio encoding method according to claim 6, wherein the obtaining the target feature based on the sixth feature, the data to be processed, and the third feature, comprises:
performing a residual processing on the sixth feature, the data to be processed and the third feature to obtain the target feature.

8. The audio encoding method according to claim 6, wherein the each residual unit further comprises a second convolutional neural network connected in series after the batch normalization layer in the residual unit;
the obtaining the target feature based on the sixth feature, the data to be processed, and the third feature, comprises:
performing a residual processing on the sixth feature and the third feature to obtain a seventh feature;
inputting the seventh feature into the second convolutional neural network comprised in the residual unit to obtain an eighth feature; and
performing a residual processing on the eighth feature and the data to be processed to obtain a target feature; wherein the target feature is the data to be processed input to a next residual unit or the result after the encoding processing.

9. The audio encoding method according to claim 1, wherein the plurality of encoder blocks are connected in series, each encoder block of the plurality of encoder blocks comprises a plurality of residual units, each residual unit of the plurality of residual units comprises the first convolutional neural network, the each encoder block further comprises a bidirectional recurrent unit which comprises the recurrent neural network, a fully connected layer, and a batch normalization layer, and the recurrent neural network, the fully connected layer, and the batch normalization layer are sequentially connected in series.

10. The audio encoding method according to claim 9, wherein any encoder block of the plurality of encoder blocks is subjected to the encoding processing by:
inputting data to be processed into the plurality of residual units of the encoder block for processing to obtain a third feature;
inputting the third feature into the bidirectional recurrent unit of the encoder block to obtain a fourth feature; and
performing a residual processing on the fourth feature and the third feature to obtain a target feature;
wherein the target feature is data to be processed input into a next encoder block or a result after the encoding processing.

11. An audio decoding method, comprising:
acquiring target encoded data; wherein the target encoded data is obtained by performing an encoding processing and then performing a quantization processing on a frame of audio data;
performing a decoding processing on the target encoded data based on a plurality of decoder blocks, wherein each decoder block of the plurality of decoder blocks comprises a first convolutional neural network and a recurrent neural network; and
converting a result after the decoding processing into target audio data.

12. The audio decoding method according to claim 11, wherein the recurrent neural network comprises a bidirectional recurrent neural network.

13. The audio decoding method according to claim 11, wherein the plurality of decoder blocks are connected in series, each decoder block comprises a plurality of residual units, each residual unit of the plurality of residual units comprises the first convolutional neural network, the recurrent neural network, a fully connected layer, and a batch normalization layer, and in the residual unit, the first convolutional neural network, the recurrent neural network, the fully connected layer, and the batch normalization layer are sequentially connected in series.

14. The audio decoding method according to claim 13, wherein any residual unit of the plurality of residual units is subjected to the decoding processing by:
inputting data to be processed into the first convolutional neural network comprised in the residual unit to obtain a third feature, wherein in response to the residual unit being a first residual unit in the plurality of residual units, the data to be processed is a result after the decoding processing, and in response to the residual unit being not the first residual unit in the plurality of residual units, the data to be processed is output data of a previous residual unit of the residual unit;
performing a residual processing on the data to be processed and the third feature to obtain a fourth feature;
inputting the fourth feature into the recurrent neural network comprised in the residual unit to obtain a fifth feature;
inputting the fifth feature into the fully connected layer comprised in the residual unit to obtain a sixth feature;
inputting the sixth feature into the batch normalization layer to obtain a seventh feature, and
performing a residual processing on at least the seventh feature and the fourth feature to obtain a target feature; wherein the target feature is data to be processed input into a next residual unit or a result after the decoding processing.

15. The audio decoding method according to claim 11, wherein the plurality of decoder blocks are connected in series, the each decoder block comprises a plurality of residual units, each residual unit of the plurality of residual units comprises the first convolutional neural network; each decoder block further comprises a bidirectional recurrent unit which comprises the recurrent neural network, a fully connected layer and a batch normalization layer, and the recurrent neural network, the fully connected layer and the batch normalization layer are sequentially connected in series.

16. The audio decoding method according to claim 15, wherein any decoder block of the plurality of decoder blocks is subjected to the decoding processing by:
inputting data to be processed into the plurality of residual units of the decoder block for processing to obtain a third feature;
inputting the third feature into the bidirectional recurrent unit of the decoder block to obtain a fourth feature; and
performing a residual processing on the fourth feature and the third feature to obtain a target feature, wherein the target feature is data to be processed input to a next decoder block or a result after the decoding processing.

17. A non-transitory computer-readable storage medium, having stored thereon a computer program which, when executed in a computer, causes the computer to perform an audio encoding method according to claim 1.

18. An electronic device comprising a memory having executable code stored therein and a processor which, when executing the executable code, implements an audio encoding method according to claim 1.

19. A non-transitory computer-readable storage medium, having stored thereon a computer program which, when executed in a computer, causes the computer to perform an audio decoding method according to claim 11.

20. An electronic device comprising a memory having executable code stored therein and a processor which, when executing the executable code, implements an audio decoding method according to claim 11.
